(19) United States
(12) Patent Application Publication
(10) Pub. No.: US 2019/0133078 A1
(43) Pub. Date: May 9, 2019

(54) Dog Toy Using Human Scent to Combat Separation Anxiety and Destructive Chewing

(71) Applicant: Eli M. Blatt, Miami, FL (US)

(72) Inventor: Eli M. Blatt, Miami, FL (US)

(21) Appl. No.: 15/805,325

(22) Filed: Nov. 7, 2017

(51) Int. Cl. A01K 15/02

(52) U.S. Cl. CPC A01K 15/025

(57) ABSTRACT

The invention relates to a novel pet dog toy wherein the toy is comprised of a reusable outer casing, which may be configured to be shaped like a traditional pet dog toy (e.g. bone, ball, animal, pet dog bed/blanket etc.) or resembling a human item (e.g., sock, shirt, shoes, etc.), or any other related item, wherein any item of the appropriate size containing a human's scent can be inserted into the toy to stimulate the pet dog to play with the toy, combat separation anxiety and destructive chewing habits.

### CROSS-REFERENCE TO RELATED APPLICATIONS

The application claims the benefit of applicant's prior provisional patent application number 62/422,370, filed on Nov. 15, 2016.

I, Eli M. Blatt, have invented a new dog toy, which utilizes human scent to combat separation anxiety and destructive chewing habits, of which the following is a specification, reference being had to the accompanying drawings, forming a part hereof.

### BACKGROUND & FIELD OF THE INVENTION

The invention most closely corresponds with USPTO Class 119/702 wherein Class 119 relates to animal husbandry and sub-class 702 includes exercise or amusement devices for animals. The invention relates to a novel pet dog toy wherein the toy is comprised of a reusable outer casing, which may be configured to be shaped like a traditional pet dog toy (e.g., bone, ball, animal, pet dog bed/blanket etc.) or resembling a human item (e.g., sock, shirt, shoes, etc.), or any other item related item, wherein any item of the appropriate size containing a human's scent can be inserted into the toy to stimulate the pet dog. Notwithstanding the aforementioned, it should be noted that the invention is not limited in form to the number of different scents that can be used simultaneously at any one time and/or the shape of human clothing, as it could take just about any other shape imaginable.

### DESCRIPTION AND CRITICISM OF PRIOR ART

The invention improves upon the prior art, including those referenced in the relevant prior art and non-patent citations sections noted below. An issue with current pet dog toys is that all of the prior art till now contain some type of toy which utilizes a food item and/or the scent of a food item inside the toy to stimulate the pet dog and attract it to, and interact with, the toy and thereby obtain the pet dog treat contained therein. But there are no prior art pet dog toys that utilize a piece of human clothing and/or a human's scent to stimulate the pet dog to play with the toy, combat separation anxiety and destructive chewing habits.Notwithstanding the aforementioned, it should be noted that the invention is not limited in form to the number of different scents that can be used simultaneously at any one time and/or the shape of human clothing, as it could take just about any other shape imaginable.

### RELEVANT PRIOR ART INCLUDES

U.S. Pat. No. 9,004,012 April, 2015 Taylor.

U.S. Pat. No. 12,927,164 November, 2010 Hansen.

U.S. Pat. No. 9,169,629 October, 1998 Zelinger.

### NON-PATENT CITATIONS

Reference: Kong Classic, Kong Toy http://www.kongcompany.com/products/dogs/kong-rubber-toys/classic/kong-classic, printed Sep. 14, 2011.

### THE INVENTION

### SUMMARY, OBJECTS AND ADVANTAGES

The invention provides a new novel way of preventing a dog from experiencing separation anxiety and curtailing entirely a dog's destructive chewing habits.

To date no dog toys have taken the shape of human clothing besides the invention herein described. No dog toys have targeted the scent of familiar human vs the scent of food. Notwithstanding the aforementioned, it should be noted that the invention is not limited in form to the number of different scents that can be used simultaneously at any one time and/or the shape of human clothing, as it could take just about any other shape imaginable.

The finding that the scent of its owner is more powerful even than the scent of food comes from new peer-reviewed research out of Emory University using fMRI machines on dogs (URL Citation:

http://news.emory.edu/stories/2017/09/esc berns dogs book/campus.html

The research conducted at Emory University showed that the scent of a familiar human or humans, but not the scent of food, activates the caudate nucleus in dogs' brains, a region of the brain which in humans is associated with pleasure. This new finding is the basis for the present innovation. Previously it was believed only the scent of food would stimulate the dog. But, there is no data to suggest that the scent of food has pleasurable properties for a dog, only that it is motivating, whereas the research out of Emory University shows that the human scent provides dogs with a unique sense of pleasure not associated with food. The implication of the research out of Emory on dogs is that while the scent of foods may be motivating, it is not pleasurable. In fact, when the dog smells food it experiences anxiety, which creates motivation to reduce the anxiety by acquiring the food. This is why no activation is seen in the caudate nucleus: the scent of food is not pleasurable or therapeutic—even if it is motivating. By contrast, the scent of a familiar human brings with it pleasurable memories of past interactions, which serves a therapeutic function that the scent of food does not provide.

Dogs are known to steal their owners' socks and other clothing, but no prior art and/or any products have leveraged that effect for functional purposes.

Furthermore, the invention has a unique utility that other toys do not have and have not contemplated. The fact that the Kong Toy, in which the owner places a piece of food for a dog was invented more than 40 years ago, and since then numerous other related prior art have been developed, but none have thus far created a product like the invention, proves that the invention is non-obvious.

Additionally, the invention has been featured in Kickstarter, Mashable and Buzzfeed, as a new, innovative and novel toy/concept, URL Citations as follows:
Kickstarter—
https://www.kickstarter.com/projects/smellysock/the-smelly-sock-the-only-dog-toy-that-smells-like, and
Mashable—http://mashable.com/2017/07/02/the-smelly-sock-for-dogs, and
Buzzfeed—
https://www.facebook.com/BuzzFeedAnimals/videos/1622180141137308/

In other words, the invention has thus far enjoyed commercial success, there has been a need in the industry for the invention, others have failed to achieve the same result, the inventor did what others have not done, and the invention has been praised by others in the field, and the underlying technology has been validated by peer-reviewed research.

Furthermore, an advantage of the invention is that it utilizes a human's scent to stimulate the pet dog to play with the toy, which no prior art claims to achieve and/or has achieved thus far.

Another advantage of the invention is that it combats separation anxiety using a toy infused with a familiar human's scent, which no prior art claims to achieve and/or has achieved thus far.

Another advantage of the invention is that it uses a toy infused with a familiar human's scent to combat destructive chewing habits, which no prior art claims to achieve and/or has achieved thus far.

### BRIEF DESCRIPTION OF THE DRAWINGS

FIG. 1—is an environmental perspective view illustrating the invention as a sock, and showing its general features, along with a scented article which also happens to be a sock.

### DRAWINGS-REFERENCE NUMERALS

1—the invention

2—scented item

3—opening to insert scented article

4—velcro strip

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in ONE (1) relatively simple figure (Sock); although sufficiently detailed to illuminate to one skilled in the art of such articles to a viable method for making or using said invention.

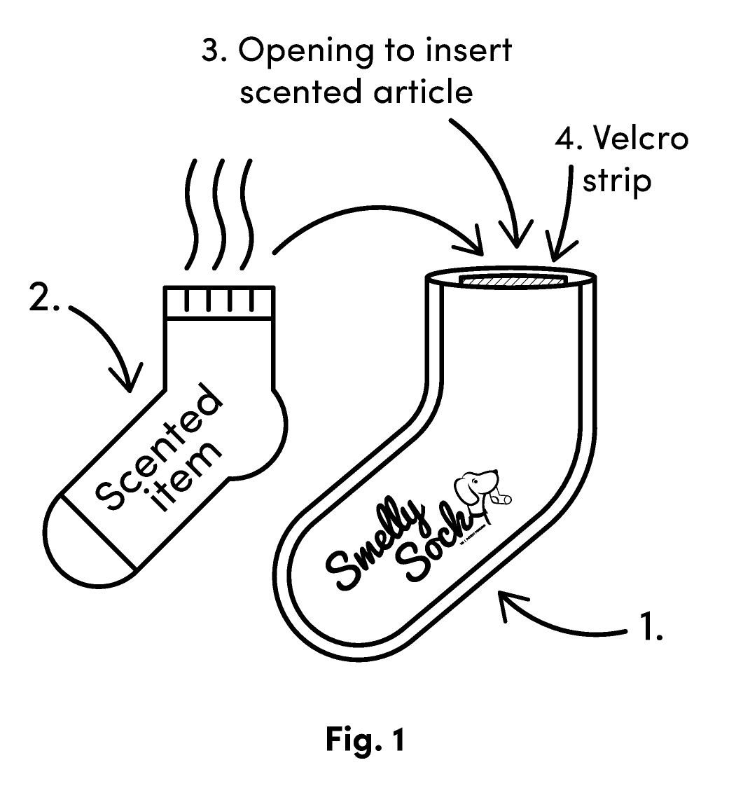

FIG. 1 is an environmental perspective view illustrating the invention in the shape of a sock constructed from a fabric material. The general features 1, 3, and 4, are shown therein. This embodiment does not come apart, but functions as a chew toy to which the pet dog will be attracted to, based on the human's scent which is found on the scented article 2, which will be placed into the invention, via the opening to insert article 4.

The invention claimed is

1. A reusable pet dog chew toy which is composed of an outer encasement with an openable or otherwise accessible to the human but not accessible to the dog scented article compartment, which is comprised of:
a) A hollow shaped encasement.
b) A secured opening, sometimes secured via velcro, used to insert the human scented articles; or alternatively a molded cavity in which the scented item can be placed by the human but which is inaccessible to the dog by virtue of its shape.
Obviously, numerous variations and modifications can be made without departing from the spirit of the present invention. Therefore, it should be clearly understood that the forms of the present invention described above and shown in the Figures of the accompanying drawing are illustrative only and are not intended to limit the scope of the present invention.
